(19) United States
(12) Patent Application Publication
(10) Pub. No.: US 2014/0144133 A1
(43) Pub. Date: May 29, 2014

(54) OVERRUN AIR RECIRCULATION VALVE

(71) Applicant: Ralf Christmann, Kaiserslautern (DE)

(72) Inventor: Ralf Christmann, Kaiserslautern (DE)

(73) Assignee: BORGWARNER INC., Auburn Hills, MI (US)

(21) Appl. No.: 14/119,244

(22) PCT Filed: May 24, 2012
(86) PCT No.: PCT/US12/39288

§ 371 Date: Nov. 21, 2013

(30) Foreign Application Priority Data
Jun. 8, 2011 (DE) 102011103607.9

(51) Int. Cl. F16K 17/10; F02B 37/18

(52) U.S. Cl. CPC F16K 17/10; F02B 37/183
USPC 60/600; 137/542

(57) ABSTRACT

A overrun air recirculation valve (1) having a housing (2) which delimits a housing interior (3); a diaphragm (4) which has a diaphragm area (A_{O}) and which divides the housing interior (3) into a first chamber (5) and a second chamber (6); and a valve plunger (7) which has a plunger area (A_{U}), which is connected to the diaphragm (4) via a valve rod (8) and which is preloaded into a closed position by means of a spring (9). The diaphragm area (A_{O}) is greater than the plunger area (A_{U}).

The invention relates to an overrun air recirculation valve as per claim 1 and to a method for controlling an overrun air recirculation valve of said type, as per claim 5.

Overrun air recirculation valves are used in engines supercharged by means of an exhaust-gas turbocharger in order to be able to prevent a situation in which, when the accelerator is released and the throttle flap closes, the compressor of the exhaust-gas turbocharger begins to surge because, owing to its mass inertia, it conveys air into a volume which is substantially closed by the throttle flap. This would have the adverse effect that the rotational speed of the exhaust-gas turbocharger would decrease very rapidly. The overrun air recirculation valve opens when a certain pressure is overshot, such that the air can be recirculated to the compressor inlet. In this way, the rotational speed of the exhaust-gas turbocharger remains high, and charge pressure is immediately available again during a subsequent acceleration process.

In the case of already known overrun air recirculation valves, the opening is effected by means of the negative pressure downstream of the throttle flap which prevails when the throttle flap is closed.

It is an object of the present invention to provide an overrun air recirculation valve whose operating characteristic is improved.

Said object is achieved by means of the features of claim 1 and the features of claim 5.

According to the invention, the overrun air recirculation valve is opened by means of the charge pressure at the pressure connecting piece of the turbocharger or in the spiral of the compressor. The overrun air recirculation valve according to the invention closes again automatically when a selectable pressure difference is overshot.

Subclaims 2 to 4 relate to advantageous refinements of the overrun air recirculation valve according to the invention.

Claim 5 defines a method for controlling an overrun air recirculation valve.

Further details, features and advantages of the invention will emerge from the following description of exemplary embodiments on the basis of the drawing, in which:

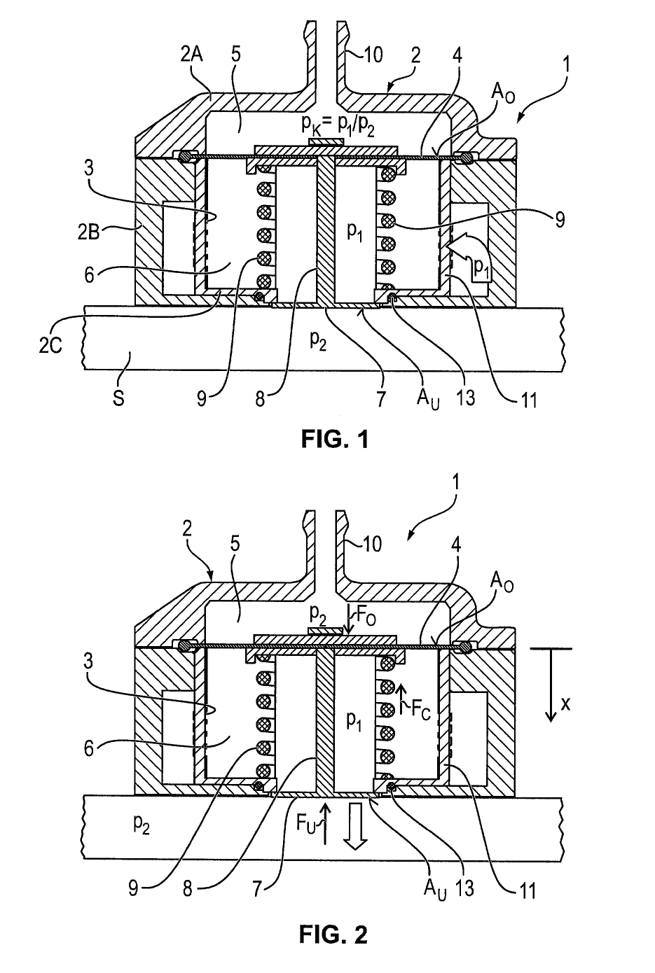

FIG. 1 shows a schematically highly simplified diagrammatic illustration of the overrun air recirculation valve according to the invention in its (actively closed) basic position,

FIGS. 2 to 5 show illustrations, corresponding to FIG. 1, of the overrun air recirculation valve in different operating states, and

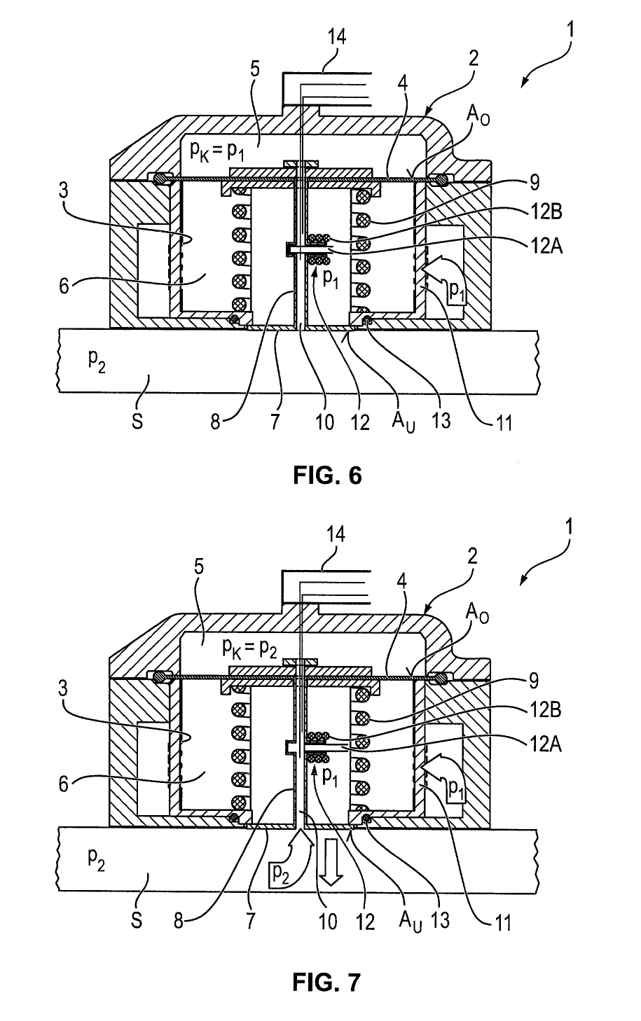

FIGS. 6 and 7 show an illustration, corresponding to FIG. 1, of a further embodiment of the overrun air recirculation valve according to the invention.

FIG. 1 illustrates an embodiment of an overrun air recirculation valve 1 according to the invention which, as explained in the introduction, can be used in an internal combustion engine with supercharging by means of an exhaust-gas turbocharger. The engine and the exhaust-gas turbocharger are not illustrated in any more detail in the figures as they are not necessary for explaining the principles of the present invention.

The overrun air recirculation valve 1 has a housing 2 which encompasses a housing interior 3.

In the housing interior 3, a diaphragm 4 is clamped between housing halves 2A and 2B. The diaphragm 4 thus divides the housing interior 3 into a first chamber 5 and a second chamber 6, wherein owing to the illustration selected in FIG. 1, the first chamber 5 is the upper chamber while the second chamber 6 is the lower chamber. The overrun air recirculation valve 1 furthermore has a valve plunger 7 which is connected via a valve rod 8 to the diaphragm 4. Between the diaphragm 4 and a lower housing wall 2C there is arranged a spring 9 which preloads the valve plunger 7 into its closed position (or actively closed basic position) illustrated in FIG. 1.

FIG. 1 also shows that the housing 2 has a pressure port 10 for the first chamber 5 and a pressure port 11 for the second chamber 6. Finally, an O-ring seal 13 is provided which seals off the two housing halves 2A and 2B with respect to one another.

As can also be seen from FIG. 1, the diaphragm 4 has a diaphragm area A_{O} and the valve plunger 7 has a plunger area A_{U}. According to the invention, the diaphragm area A_{O} is greater than the plunger area A_{U}.

The overrun air recirculation valve 1 is arranged on a spiral S, illustrated in schematically simplified form, of a compressor which is not illustrated in detail in FIG. 1 and in which a pressure p₂ prevails. In the first chamber, a chamber pressure PK prevails which may assume either the value p₁ or the value p₂ of the spiral S. FIG. 2 shows an operating state for the opening of the first or upper chamber 5, for which purpose the pressure p₂ is introduced into said chamber 5. This yields the following force relationships:

$$\begin{matrix}Δ F = {F}_{O} - {F}_{U} - {F}_{C} \\ = {A}_{O} {p}_{2} - {A}_{O} {p}_{1} - ( {A}_{U} {p}_{1} - ( {A}_{U} {p}_{2} - {A}_{U} {p}_{1} ) - {F}_{C} \\ = {A}_{O} ( {p}_{2} - {p}_{1} ) - {A}_{U} ( {p}_{2} - {p}_{1} ) - {F}_{C} \\ = ΔA \cdot Δ p - {F}_{C}\end{matrix}$$

where

ΔA=A_{O}-A_{U}; Δp=p₂-p₁ and F_{C}=F₁+c.x

and

x=0:

ΔF >0,

because

A_{O}>A_{U}, if

ΔA Δp>F₁.

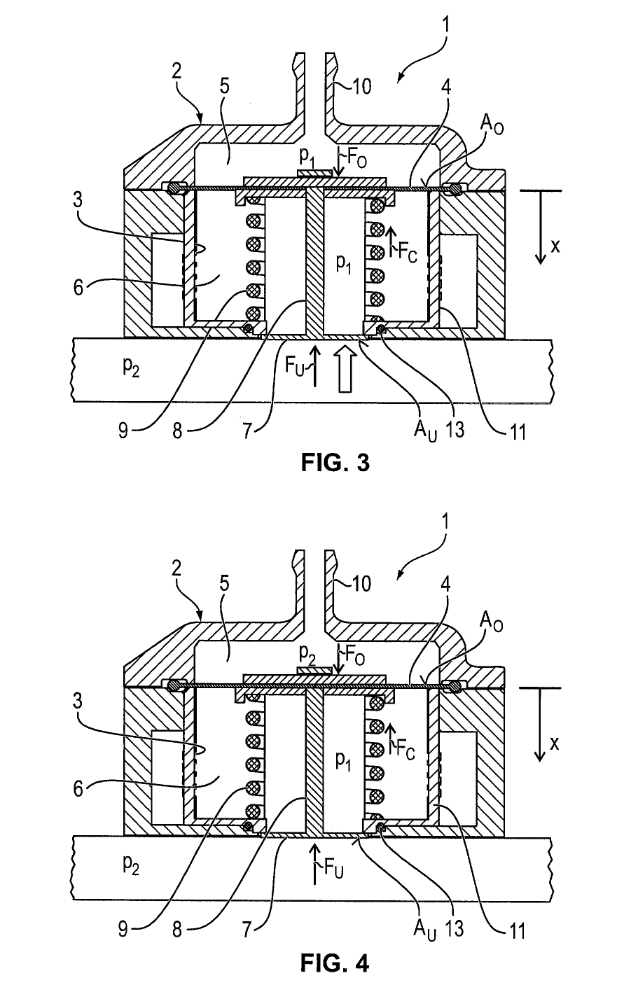

FIG. 3 shows the overrun air recirculation valve 1 in the actively closed basic position, for which purpose, for closing, the pressure p₁ is introduced into the upper chamber 5. This yields the following force relationships:

$$\begin{matrix}Δ F = {F}_{O} - {F}_{U} - {F}_{C} \\ = {A}_{O} {p}_{K} - {A}_{O} {p}_{1} - ( {A}_{U} {p}_{2} - {A}_{U} {p}_{1} ) - {F}_{C} \\ = ( {p}_{1} - {p}_{2} ) \cdot {A}_{U} - {F}_{C} \\ - Δ \dot{p} {A}_{U} - {F}_{1} \\ < 0 ! , because Δ p = {p}_{2} - {p}_{1} > 0.\end{matrix}$$

In this situation, the overrun air recirculation valve 1 remains firmly closed.

The following may serve as an example for the dimensioning of the surfaces:

A_{O}=2.A_{U};

d_{U}=20 mm [symbol] A_{U}=314 mm²

A_{O}=628 mm²

F₁=1N

FIG. 4 illustrates the force relationships for the opening of the overrun air recirculation valve 1. For this purpose, the pressure p₂ from the spiral S is introduced into the upper chamber 5. Taking the exemplary values from FIG. 3 as a basis, the following situation arises:

Δpₘᵢₙ: Δp>F₁/ΔA

>1N/314 mm²=31.8 mbar

[symbol]

Δpₘᵢₙ=p₂-p₁>31.8 mbar.

In this operating situation, the overrun air recirculation valve 1 switches or opens.

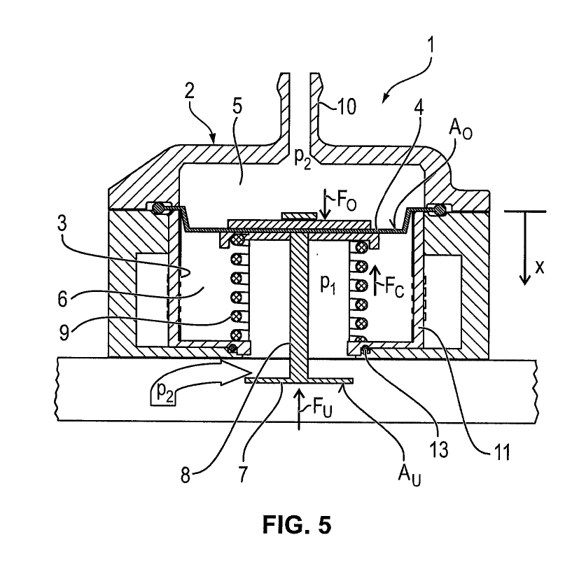

FIG. 5 illustrates an operating position in which the overrun air recirculation valve 1 is open and, taking the following exemplary values as a basis, the following pressure difference Δp arises:

A_{O}=2.A_{U};

d_{U}=20 mm [symbol] A_{U}=314 mm²

A_{O}=628 mm²

F_{C}=1N+0.1 N/mm5 mm=1.5N

Δp <F_{C}/ΔA=1.5N/314 mm²

<47.8 mbar.

At the pressure difference Δp explained above, the overrun air recirculation valve 1 closes again, wherein the pressure p₂ prevails, as before, in the upper or first chamber 5.

FIGS. 6 and 7 illustrate a further embodiment of the overrun air recirculation valve 1 according to the invention. All features corresponding to those of FIGS. 1 to 5 are denoted by the same reference symbols, such that in this regard reference can be made to the description above.

The overrun air recirculation valve 1 as per FIGS. 6 and 7 is provided with an integrated solenoid valve 12 which comprises a magnet 12A and a coil 12B which are illustrated in schematically simplified form in FIGS. 6 and 7.

The coil is provided with a 2-pin plug 14.

Furthermore, the illustration of FIGS. 6 and 7 shows that the pressure port 10 into the first chamber 5 runs via the valve rod 8.

FIG. 6 shows the actively closed basic position of the overrun air recirculation valve 1, in which the magnet 12A is not activated and consequently closes the pressure port 10 in the valve rod 8. Accordingly, the pressure p₁ prevails in each case in the first chamber 5 and in the second chamber. FIG. 7 shows, by contrast, a basic position of the overrun air recirculation valve 1 for the opening thereof, in which the magnet 12A is attracted such that the pressure port 10 is opened up. Accordingly, in said position, the pressure p₂ of the spiral S prevails in the chamber 5, while the pressure p₁ prevails in the chamber 6. Said operating position constitutes the basic position of the overrun air recirculation valve 1 for opening.

In addition to the above written disclosure of the invention, reference is hereby made explicitly to the diagrammatic illustration thereof in FIGS. 1 to 7.

### LIST OF REFERENCE SYMBOLS

1 Overrun air recirculation valve

2 Housing

2A, 2B Housing halves

3 Housing interior

4 Diaphragm

5 First chamber

6 Second chamber

7 Valve plunger

8 Valve rod

9 Spring

10, 11 Pressure ports

11 Solenoid valve

12A Magnet

12B Electrical coil

13 O-ring

14 2-pin plug

A_{O} Area of the diaphragm 4

A_{U} Area of the valve plunger 7

p₁ First control pressure

p₂ Second control pressure

PK Pressure in chamber 5 (either p₁ or p₂)

F_{O} Diaphragm force

F_{U} Plunger force

F_{C} Spring force

c Spring constant

F₁ Spring preload force

Δpₘᵢₙ Minimum pressure difference for opening the overrun air recirculation valve

1. An overrun air recirculation valve (1) having
a housing (2) which delimits a housing interior (3);
having a diaphragm (4)
which has a diaphragm area (A_{O}) and
which divides the housing interior (3) into a first chamber (5) and a second chamber (6); and
a valve plunger (7)
which has a plunger area (A_{U}),
which is connected to the diaphragm (4) via a valve rod (8) and
which is preloaded into a closed position by means of a spring (9),
wherein the diaphragm area (A_{O}) is greater than the plunger area (A_{U}).

2. The overrun air recirculation valve as claimed in claim 1, wherein the first and second chambers (5, 6) have in each case one pressure port (10 and 11 respectively).

3. The overrun air recirculation valve as claimed in claim 1, characterized by an integrated solenoid valve (12) arranged in the housing interior (3).

4. The overrun air recirculation valve as claimed in claim 3, wherein the solenoid valve (12) is arranged in the second chamber (6).

5. A method for controlling an overrun air recirculation valve (1) as per claim 1, wherein the pressure in a charge-pressure connecting piece of an exhaust-gas turbocharger is used for opening the valve plunger (7).

6. A method for controlling an overrun air recirculation valve (1) as per claim 1, wherein the pressure in the compressor spiral of an exhaust-gas turbocharger is used for opening the valve plunger (7).
